(19) United States
(12) Patent Application Publication
(10) Pub. No.: US 2020/0222929 A1
(43) Pub. Date: Jul. 16, 2020

(54) SMART SPRAY PAINTING NOZZLE AND CALIBRATION METHOD FOR USE WITH MOBILE ROBOTS

(71) Applicant: DISNEY ENTERPRISES, INC., Burbank, CA (US)

(72) Inventors: PAUL A. BEARDSLEY, ZURICH (CH); JAN WEZEL, ZURICH (CH); DOROTHEA REUSSER, ZURICH (CH)

(21) Appl. No.: 16/246,737

(22) Filed: Jan. 14, 2019

(51) Int. Cl. B05B 12/08

(52) U.S. Cl. CPC B05B 12/082

(57) ABSTRACT

A smart nozzle assembly includes a nozzle, a nozzle control mechanism, and camera rigidly attached to the nozzle for use with a mobile robot in an autonomous spray painting system. The nozzle control mechanism is configured to control flowrate, control the shape of the spray pattern, mix two or more colors, and clean dried paint at the nozzle tip. The nozzle assembly further includes a process for running software to manage or initiate the nozzle control mechanism's functionality and to provide the nozzle calibration. The calibration method for the nozzle uses a novel algorithm that measures the spray pattern, the distribution of paint within the spray pattern, and the relative position of the nozzle and camera. The distribution of paint within the spray pattern is measured in terms of physical quantity of delivered paint per unit area.

### BACKGROUND

### 1. Field of the Description

The present invention relates, in general, to methods and devices for use in painting structures such as multicolor designs/textures (including signs with text), and, more particularly, a smart and practical spray paint nozzle, and to a calibration method for such a nozzle, for use with a mobile robot operated to paint exterior surfaces such as themed surfaces found in amusement parks and the like (e.g., a painting robot with such a nozzle such as a drone or unmanned aerial vehicle (UAV) adapted for unpiloted and automated painting).

### 2. Relevant Background

Painting remains a costly and time consuming maintenance task for owners and operators of many facilities as these facilities may include many large painted structures. Surfaces of many structures have to be periodically repainted as part of an ongoing and routine maintenance of the facilities. These surfaces may be quite large in size, may be irregular in configuration (e.g., not always be smooth and/or planar), and may be difficult to access such as due to their significant elevation requiring scaffolding or a painter's cradle to perform painting. As a result, painting can be relatively expensive due not only to costs associated with the paint used for the work but also due to labor costs and costs of equipment used to access these surfaces.

Painting, including painting of large structures such as scenery and ride components in amusement parks, generally remains a task performed using human labor (i.e., painters). One issue with such conventional painting is that it requires skilled labor and is expensive. Another problem with conventional painting methods is that some large structures, such as rockwork and other scenery at a theme park or architectural ornamentation of nearly any large facility, are difficult to access by the painters (e.g., rollercoaster scaffolds and rails). A further problem with conventional painting is that many structures have surfaces decorated with multi-color designs and/or textures that have to be repainted over time to maintain their appearance. However, the painters will not be the same with each repainting process such that it may be difficult to retain the original appearance with each painter diverging to some degree from the original painter of each surface.

Hence, there remains a need for new methods and tools for initial painting and later repainting of surfaces of large structures. Preferably, such painting methods and tools would be less expensive to purchase and easier and safer to use for painting larger structures with 3D surfaces, which may present human access challenges and which may be painted with a specific multicolored design and/or texture, than conventional painting with skilled labor.

### SUMMARY

With regard to painting large structures and the above-discussed problems, one approach is to use mobile robots to perform the painting instead of using human workers or painters. These mobile robots may take the form of a drone or UAV such as a quadcopter or the like. For example, it is difficult for humans to access many large structures that may have irregular or 3D surfaces (rather than simple planar surfaces), but a drone can be controlled to fly nearly anywhere in space nearby the structure's surfaces. Also, in the past, the person performing repainting changed over time, but a drone can be controlled to perform an identical painting routine each time to provide a consistent appearance for painted surfaces.

It is desirable to design and create a spray paint nozzle that is suitable for use by an autonomous painting robot. The new spray paint nozzle should be capable of painting general structures in outdoor environments including painting of multi-color textures and gradients (and/or fades). There are two additional preferable attributes for the nozzle: (a) the nozzle or nozzle unit/assembly should be have a plurality of functionalities including control of flowrate, control of the shape of the spray pattern, mixing of two or more colors in the nozzle, and a self-cleaning mechanism so that paint cannot dry on the tip and block the nozzle; and (b) the nozzle unit/assembly should be “smart” in that it is capable of running a calibration method/algorithms to measure the nozzle's spray pattern shape and distribution of paint output within the spray pattern. A built-in camera is included in the nozzle unit/assembly to collect digital images that can be processed by a processor running self-calibration software to perform the calibration method/algorithm.

In one embodiment, the nozzle assembly includes a nozzle, a nozzle control mechanism, and camera rigidly attached to the nozzle. The nozzle control mechanism is configured to control flowrate, control the shape of the spray pattern, mix two or more colors, and clean dried paint at the nozzle tip. The nozzle assembly further includes a process for running software to manage or initiate the nozzle control mechanism's functionality and to provide the nozzle calibration. The calibration method for the nozzle is a novel algorithm that measures the spray pattern, the distribution of paint within the spray pattern, and the relative position of the nozzle and camera. The distribution of paint within the spray pattern is measured in terms of physical quantity of delivered paint (e.g., volume in milliliters (ml)) per unit area and not only a relative density. Two variants of the method are also provided: (a) for the common case that the nozzle is generating a cone-shaped spray; and (b) for a nozzle that is generating an arbitrary spray pattern.

More particularly, a system is provided for autonomous spray painting. The system includes a mobile robot and a nozzle assembly. The nozzle assembly (or unit) includes a nozzle, a camera (that may be affixed to the nozzle or to a frame (coupled to the mobile robot) supporting both the nozzle and the camera), a nozzle control mechanism, and a calibration unit. During a calibration process performed during operations of the system, the nozzle control mechanism operates to output a flow of paint through the nozzle in at least first and second spray patterns. Also, during the calibration process, the camera captures images of the first and second spray patterns. Then, the calibration unit processes the images of the first and second spray patterns to calibrate the nozzle.

In some embodiments, the camera is rigidly supported in the nozzle assembly at a location relative to an outlet of the nozzle, and the calibration unit is configured to calibrate (or calculate) a position of the nozzle relative to the camera. In some cases, the calibration unit calibrates the nozzle by measuring a parametric or non-parametric model of the first and second spray patterns. In more specific implementations, the calibration unit calibrates the nozzle by positioning the nozzle to apply the first and second spray patterns on first and second parallel calibration targets at known distances from the nozzle and wherein the images of the first and second spray patterns include the first and second calibration targets. Then, the calibration unit calibrates the nozzle by finding corresponding points in the first and second spray patterns. Further, the step of finding the corresponding points involves computing a homography between the images of the first and second spray patterns.

In some implementations of the spray painting system, the calibration of the nozzle by the calibration unit includes at least one of measuring the first and second spray patterns and measuring the distribution of the paint within the first and second spray patterns in terms of physical quantity of delivered paint per unit area. In the same or other implementations, the nozzle control mechanism may include at least two of: a flow rate controller operable to set a rate of the flow of the paint through the nozzle; a mixer mixing two or more input paint flows of two or more differing colors to define a color of the paint flowing through the nozzle; a spray pattern selector adjusting the nozzle to define a shape of a spray pattern output by the nozzle; and a self-cleaning device operable to remove paint buildup from an outlet of the nozzle.

From the above summary and following detailed description, it should be understood that the corresponding points in the spray patterns are found (as part of the calibration process) in order to infer the set of individual “rays” of paint. Here, the term “ray” is used in the same way that one uses it for a pinhole device like a camera or projector. In the calibration process, it is the set of all paint rays that determines the spray pattern. Also, it should be understood that calibration is needed or at least desirable in many applications. Accurate painting of texture in particular requires a way to predict how sprayed paint is distributed on the surface, for a given relative position of the nozzle and surface, and that prediction is available once the nozzle is calibrated.

### BRIEF DESCRIPTION OF THE DRAWINGS

FIG. 1 is side perspective view of a painting system of the present description during its use in painting a large structure (e.g., a large rocky scenery or decorative structure);

FIG. 2 illustrates the painting system of FIG. 1 in greater detail during painting of the structure;

FIG. 3 is a schematic or block diagram of a painting drone useful in the painting systems of the present description (such as the systems of FIGS. 1 and 2);

FIG. 4 is a top perspective of another embodiment of a drone or paintcopter for use in a painting system of the present description;

FIG. 5 is a functional block diagram of a mobile spray painting robot with a smart nozzle unit of present description; and

FIG. 6 is a flow diagram of a calibration method of the present description for use with a smart spray painting nozzle.

### DETAILED DESCRIPTION

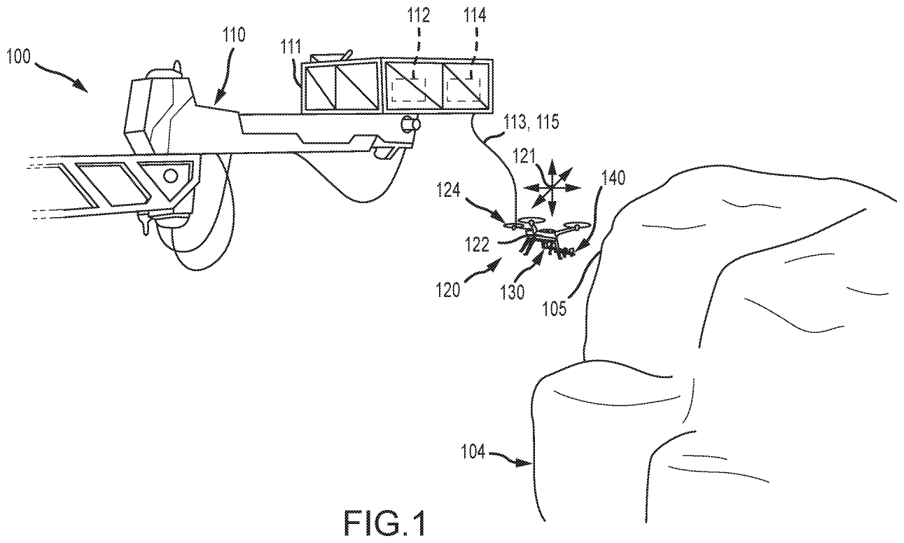

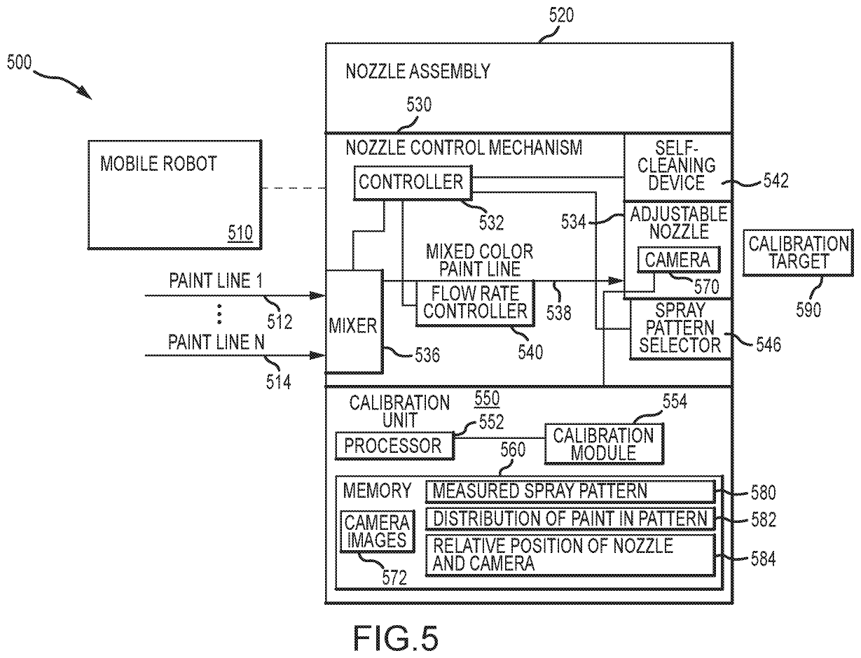

The following provides a description of a nozzle unit or assembly for a robot (such as a drone or UAV) for use in an autonomous spray painting system. The mobile robot may use the new nozzle with its calibration method to perform the painting of surfaces of large structures that are difficult for a human painter to access. Going beyond the basic functionality of painting a single color on a planar surface, the painting system is designed to support the painting of multicolor designs/textures and the painting of surfaces of a 3D (or nonplanar) structure. In general, nearly any type of painting may be performed by the painting system including multicolor designs/textures, which is meant to include painted signs with text as well as textures like themed rockwork, scenery, and the like. The description begins with description of FIGS. 1-4 and a painting system in which the mobile robot with the new nozzle unit takes the form of a drone. The description then proceeds with FIG. 5 to provide more detailed explanation of the new nozzle assembly/unit and its unique combination of functions and its new calibration method.

Prior nozzles did not have the capability to mix two or more colors in the nozzle. One previous solution for mixing colors is to mix a large batch before painting and supplying this mix to the nozzle. Another previous solution for painting color gradients and/or fades is to do sequential application of individual colors under human control to achieve a required gradient and/or face, but this is a very arduous and costly process. Traditional industrial painting robots are based on fixed robot arms such as those used on assembly lines in the automotive and other industries. The nozzles on these robot arms are designed for carefully controlled factory environments and not for a mobile painting robot that is capable of painting general objects and surfaces in outdoor environments. Robot arm nozzle units do not include the combination of the functions provided by the nozzle control mechanism of the new nozzle assembly for mobile robots.

More recently, there has been attention paid to robots that create painted art. Most of the attention is on robot brush painting while a limited amount of work has been on robot spray painting. However, this has involved using commercially available nozzle units that do not combine the functionalities of the present description nor do they provide the nozzle calibration method of the new nozzle assembly or unit. Specifically, existing calibration processes include pressure profile systems that measure spray patterns using capacitance and not distribution of paint in terms of physical quantity of deposited paint. Optical systems have been created that use a laser, and mechanical systems have been generated that collect fluid in individual cells. However, no existing nozzle calibration system integrates a spray paint nozzle with a camera along with a processor and instructions/code (or software or modules) to provide a calibration method/algorithm as described herein.

As will be understood from the following description, a first difference between the new nozzle assembly and prior nozzle designs is that the new nozzle assembly combines all the necessary functions for robotic painting of general surfaces into a single unit. A second difference is the algorithm of the calibration method. Previous solutions for measuring spray are high-end devices specialized for industrial use and use capacitance, laser, or mechanical collection. In contrast, the calibration method taught herein by the inventors requires only the mechanism to control flow rate and the built-in camera so that it is much less expensive. The calibration can be readily done outdoors during a painting job, requiring only the nozzle unit itself and a simple calibration target. In some cases, a pressure profile systems device may cost around $30,000 USD and does not provide as full a calibration solution as the proposed calibration algorithm whose biggest cost is an off-the-shelf digital camera that may cost about $100 USD. An advantage of the nozzle assembly with the calibrated nozzle is that delivery of paint on a surface is known precisely. Thus, an automatic algorithm can use the nozzle characteristics to determine robotic painting commands to generate a desired surface appearance, e.g., a rockwork appearance. Another advantage of the nozzle assembly or unit is that it is able to paint smooth color gradients, varying from one color to another via intermediate shades due to its color mixing functionality, which is useful in painting many surfaces such as exterior surfaces of artificial rockwork structures.

FIG. 1 illustrates an exemplary painting system 100 of the present description during its use in painting a 3D surface 105 of a large structure 104 (e.g., a rocky scenery or decorative structure that may be painted with texture and that includes irregular 3D surfaces rather than only 2D or planar surfaces). The system 100 is shown to include a supply support assembly 110 in the form, in this example, a cherry picker or crane with a cage/box 111 supported in midair above the target surface 105 of the structure 104. Within the cage/box 111, the system 100 includes a power source or supply 112 along with a paint (and air) supply 114 (e.g., with a liquid pump for paint (e.g., of two or more colors during mixing operations) and/or compressor for providing compressed air), and power and paint supply lines 113, 115 (and a separate air line in some cases) are fluidically coupled at a first end to supplies 112, 114 and a second end to a mobile robot (in this non-limiting example, a drone) 120 (e.g., to a nozzle assembly or unit 140 (that may provide pan-tilt functions in some cases)). In other embodiments, though, the paint supply is provided onboard.

The painting system 100 further includes the mobile robot (e.g., a quadcopter or the like) 120 with a body 122 that is moved in any direction (as shown with arrows 121) via operation of rotors 124 by an onboard controller (not shown in FIG. 1) to follow a painting trajectory (stored in memory on body 122). The drone 120 is modified to include a support arm 130 that is affixed at one end to the body 122 of the drone 120, and the arm 130 is typically formed with one, two, or more rods, struts, or tubes of rigid but lightweight material (such as a plastic) and has a length that is chosen to position the arm's second, distal end a predefined distance from the body 122 to place it outside the diameter of rotation for the rotors 124 (e.g., outside a wash zone generated by movement of the rotors 124). At this distal, second end of the arm 130, a pan-tilt paint nozzle assembly or unit 140 is mounted, and the power and paint supply lines 113, 115 (e.g., providing two colors for mixing by the nozzle assembly 140) are fluidically coupled to the inlet of the nozzle assembly 140 to enable spray painting during operation by an onboard controller of the nozzle assembly 140 (by implementing paint commands annotated onto a 3D model of the structure 104). The system 100 is autonomous as no manual drone pilot or mobile robot operator is required.

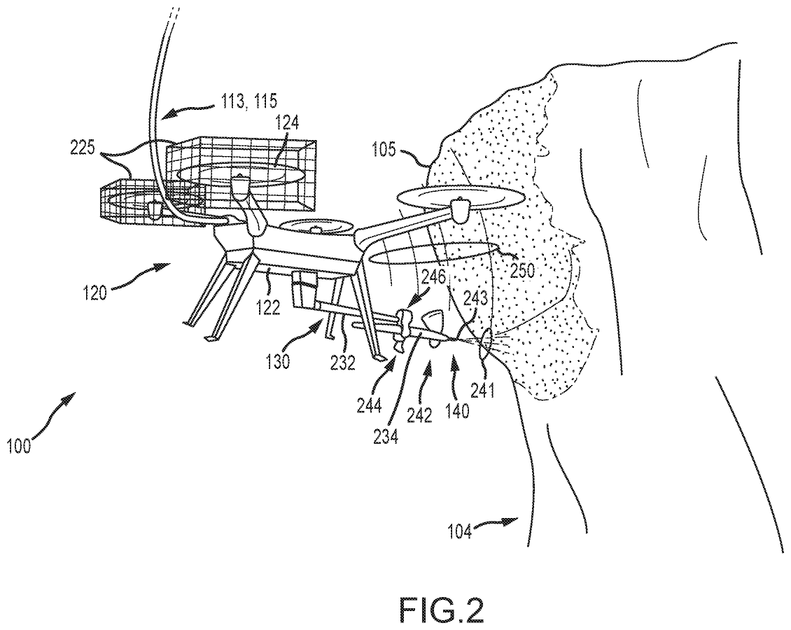

FIG. 2 illustrates an enlarged view of the painting system 100 of FIG. 1 showing additional details of the modified paintcopter 120. To avoid contact between the lines 113, 115 and rotors 124, rotor enclosures 225 are shown covering at least two of the rotors 124 (e.g., the two rotors 124 between which the lines 113, 115 are run to enter the body 122). The rotor enclosures 225 typically will be formed of a lightweight screen or mesh, to limit air resistance and reduce weight such as one formed of plastic. The power supply line 113 may be a very thin and lightweight wire that may provide greater than 400 volts or the like, and this eliminates the need for a battery on the drone 120. Hanging the lines from above by positioning the supplies 112, 114 above the surfaces 105 to be painted with the drone 120 is desirable in many applications as it takes weight off the drone 120 (e.g., it avoids trailing weight of the lines 113, 115 if provided with lower elevation supplies). The controller of the paintcopter 120 is shown with waves/signals 250 to be operating its onboard sensor(s) to be sensing the 3D surface 105 of the structure 104, and this sensed information is processed to provide localization of the body 122 and, in turn, the nozzle 140 by comparing the sensed information to the 3D map of the target surface 105.

In this embodiment of the drone 120, the support arm 130 is shown to be a two-piece design with an inner arm 232 attached at one end to the body 122 and at a second end to an outer arm, which supports the nozzle 140 with its outlet 243. To disperse or spray paint 241 onto the surface 105, the nozzle assembly 140 includes an actuator 242 that can be operated by the controller to open and close based on a set of paint commands mapped to the 3D model of the structure 104. The nozzle assembly 140 further includes a tilt motor 244 for tilting the outer support arm 234 and nozzle outlet 243 relative to the rigid inner arm 232. Additionally, a pan motor 246 is provided at the end of the inner support arm 232 to rotate or spin the outer support arm 234 and nozzle outlet 243 relative to the fixed outer or second end of the inner support arm 232. The operation of the tilt and pan motors 244, 246 based on the painting commands by the controller provides the fine localization control over the painting 241 of surface 105 while operation of the rotors 124 in response to sensed 250 surface information provides gross localization control (or gross 3D positioning of the paintcopter 120 and nozzle assembly 140).

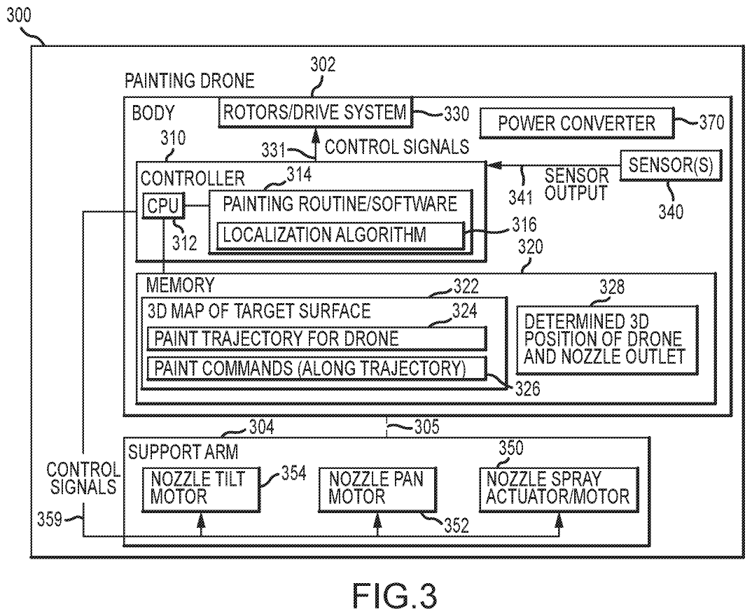

FIG. 3 illustrates a block diagram showing schematically the hardware and software components of an exemplary painting mobile robot (e.g., a drone or UAV) 300, with a nozzle assembly useful with the robot 300 being discussed beginning with FIG. 5). As shown, the drone 300 includes a body 302 with a drive system (with multiple rotors in most cases) 330 that are operated to selectively position or fly the body 302 in space (e.g., in 3D positions or locations set by a painting trajectory 324). The body 302 is shown to include a power converter 370 for converting (e.g., AC-to-DC or DC-to-DC conversion) power from a power source that is located offboard and is connected to the converter 370 via a power supply line (not shown in FIG. 3 but seen in FIGS. 1 and 2) for use by onboard components such as the rotors/drive system 330, the motors 350, 352, 354 on the support arm (or elements of a nozzle assembly), the processor 312, and the sensor(s) 340. In this manner, when a commercial drone is used as the base for the painting mobile robot 300 it can be modified to remove the battery to limit its weight and/or provide space for added components including the sensor 340 and controller 310. It may be desirable to have the center of mass of the drone 300 remain near the center of the body 302 and the position of the converter 370 and controller 310 may be chosen to offset weight added with the support arm 304 and other drone components.

The painting drone 300 is further shown to include the onboard controller 310, which is configured to make the drone 300 autonomous (not require a human pilot for positioning or for painting operations). To this end, the controller 310 includes a processor 312 that operates to manage access to and from memory/data storage 320 on the body 302 and to execute code/software including the painting routine/software 314 to provide the functionality described herein. These functions include generating and transmitting control signals 331 to the rotors/drive system 331 to fly and position the drone 300 as well as generating and transmitting control signals 359 to the nozzle spray actuator/motor 350, the nozzle pan motor 352, and the nozzle tilt motor 354. The control signals 331 and/or 359 may be transmitted wirelessly in some cases but, more typically, the controller 310 is wired to each of these devices (including sensor(s) 340) to avoid or limit the use of wireless communications in a drone-based painting system. Note, in this regard, the use of an onboard controller 310 running a painting routine/program 314 is useful to avoid wireless communications with a base station/control system that can be problematic (e.g., can involve undesirable delays, missed signals, and the like).

Prior to painting operations, a 3D map or model of the target surface 320 to be painted is scanned/generated and stored in memory 320 on the drone 300. The 3D model 320 is annotated with the paint trajectory (or flight path) for the drone 300 so as to position it through a plurality of 3D positions along or relative to the targeted surface defined in the 3D model 320. Further, a set of paint commands 326 are used to annotate the 3D model 322 so as to define where paint is to be applied along the trajectory 324 and, in some cases, what colors and/or texturing (painting techniques) are to be used. A sensor(s) 340 is provided that is operated by the controller 310 to generate sensor output 341 that provides information regarding a targeted surface of a structure (e.g., shows what the sensor such as a camera “sees” nearby the flying drone 300 and this camera 340 may be rigidly mounted or attached to the nozzle as discussed below for an exemplary nozzle unit to facilitate calibration), and, in some embodiments, sensor(s) 340 may include one or more GPS components to provide a “gross” position 341 of the drone 302 while a camera or other sensors can be used to provide fine tuning of the localization.

The sensor output 341 is processed by a localization algorithm 315 run by or accessed by the painting routine/software 314 to determine a 3D position of the drone and/or paint nozzle outlet as shown being stored in memory 320 at 328. This 3D position 328 is used by the painting routine/software 314 to issue control signals 330 to the drive system 330 to follow the paint trajectory 324 and also to implement the paint commands 326 to operate the nozzle spray actuator/motor 350 with control signals 359. This position 328 is also used by the painting routine/software 314 to generate control signals 359 to the nozzle pan motor 352 (for left and right movements) and nozzle tilt motor 354 (for up and down movements) to provide a higher frequency and finer level of control of the output of the spray nozzle than can be provided with control signals 331 to the drive system 330 (e.g., to make smaller position adjustments than possible with the rotors and/or to in real time correct for small movements of the drone body 302 (such as due to wind or the like)). As shown at 305, the motors 350, 352, 354 are supported on or in a support arm 304 that is attached to the body. The support arm 304 is adapted to position the outlet of the nozzle a predefined distance away from the body 302 so as to not be directly below the spinning rotors (or, in some cases, outside the rotor wash).

The drone 300 is autonomous in that it can sense the environment about its body 302 with sensors 340 as it flies (or makes a painting run), and its controller 314 with localization algorithm 316 can process the sensor output 341 to determine the 3D position to provide localization. The localization (or 3D position) is used to implement the paint trajectory 324 as well as to provide live painting or depositing via the paint commands using the 3D map/model 324 of the surfaces of the targeted structure. A camera may be used for sensor(s) 340 to provide visual sensing 341 of the environment including both color and depth of the 3D surface being painted while infrared (IR) projection may be used also or instead be used to provide the information useful in generating the 3D position of the drone and is carried paint nozzle (e.g., determine the position of the nozzle outlet down to about 2 centimeters using a combination of the prescanned 3D map/model 322 and the sensor output 341 rather than within about 2 meters when rely solely on GPS-based techniques).

With regard to hardware used to implement a drone-based painting system, the paintcopter (e.g., that shown in FIGS. 1-4) may be implemented using a commercially-available drone (e.g., a DJI Matrice drone or the like) that is customized with an arm plus a pan-tilt spray nozzle and/or with the nozzle assembly/unit described below beginning with FIG. 5. The sensor unit may also be implemented using commercially-available sensors such as a DUO MLX stereo camera-IMU or the like that may be supplemented with an Intel Real Sense RGB-D sensor or the like. Flight time using an onboard battery can be too time limited for industrial painting tasks, and the drone's battery was replaced by a power supply line connected to an external power source. Similarly, painting using an onboard paint reservoir can be too limited in terms of surface area than can be painted on each flight, and the painting system is designed to supply paint via a line from an external compressor (paint supply) to the paint nozzle. The power and paint supply lines arrive from a point above the drone (supplies/sources positioned at a greater elevation than the target surface on the structure), and a mesh cage may be provided on the drone to prevent contact with the propellers/rotors.

Regarding system operations, firstly, a 3D model is captured for the target surfaces that are to be painted. Secondly, a designer specifies the desired surface appearance using the 3D model (in an offline process). The designer specification is used to generate (automatically in some embodiments) the drone trajectory plus the pan-tilt spray nozzle control commands to product that appearance. Thirdly, in the live system, the drone localizes relative to the physical surface using the 3D model, and painting is done using the stored drone trajectory and spray nozzle commands.

With regard to painting texture, one design goal for some embodiments of the painting system is to paint texture including varying color, gradients, and lines as opposed to flat color. An example would be to paint a homogenous surface so that it looks like brickwork. Painted texture is not common because it requires skilled work approaching artistry. However, a robotic approach such as that brought by the drone-based painting system opens up the potential for painted texture. Different colors on the surface are achieved by sequential spraying of different densities of different color paint. In order to transition between colors, the drone may dock to allow the paint line to be manually exchanged. Prototyping and testing have demonstrated use of a drone from 3D capture of target surface through generation of drone trajectory and spray nozzle commands and through painting on a 3D textured object.

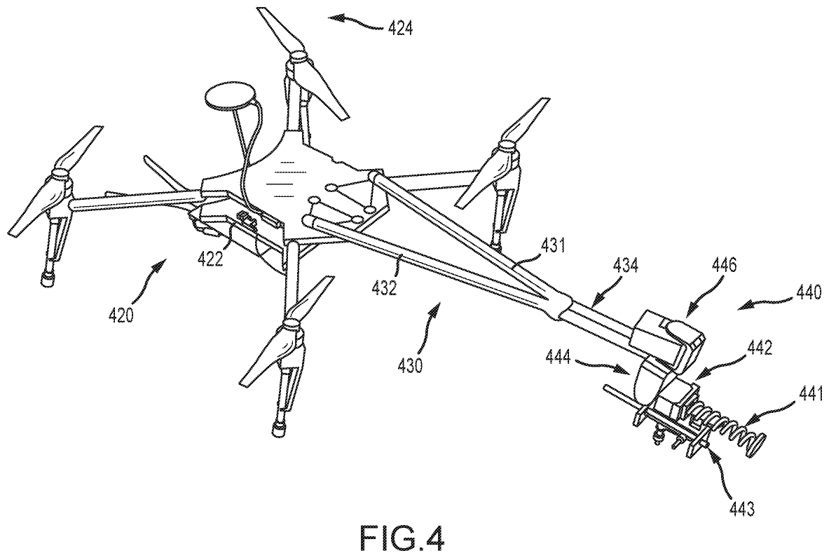

FIG. 4 is a top perspective view of another embodiment of a paintcopter or drone 420 that may be used in a painting system of the present description (such as in system 100 in FIGS. 1 and 2). As shown, the drone 420 includes a body 422 that is used to house the sensors, the controller, and the memory as well as any power converters used to deliver power from an external source/supply to the onboard devices and the motors/actuators of the nozzle assembly 440. A set of propellers or rotors 424 are used to fly the drone 420 about a space proximate to a structure with a 3D surface targeted for painting.

The support arm 430 in this embodiment is shown to include left and right (or first and second) inner arms 431, 432 that are in the form of rigid tubes/cylinders through which a power supply line and a paint supply line (and, in some cases, a compressed air line) are run, respectively. The two arms 431, 432 are fixed at a first end to the body 422 and extend outward (e.g., generally horizontally relative to the body 422 in a plane parallel to a plane in which the rotors 424 rotate) a distance beyond the outermost diameter of the nearby rotor pair. The support arm 430 includes an outer arm 434 after which the inner arms 431, 432 have been coupled and/or positioned proximate to each other or in contact with each other as shown.

A nozzle assembly 440 is mounted at the outermost end of the outer arm 434. The nozzle assembly 440 is shown to include a nozzle/nozzle outlet 443 through which paint is sprayed during painting operations with the drone 420, and a motor/actuator 442 is provided for selectively opening and closing an upstream valve(s) (e.g., in response to control signals from the controller in body 422) to spray the paint (and compressed air if separately supplied) from the nozzle/nozzle outlet 443. A protective element 441 that may take the form of a spring is provided adjacent the nozzle 443, and the protective element 441 extends parallel to the nozzle 443 but a distance greater than the nozzle 443 from the end of the arm 434 so that the nozzle 443 is protected from inadvertent collisions with 3D surfaces being painted (which will first collide with the outer end of the spring or other protective element 441).

The nozzle assembly 440 provides both pan (or yaw) and tilt (or pitch) motion for the nozzle 441. To this end, the nozzle assembly 440 includes a tilt motor 444 for tilting the nozzle 441 up and down relative to containing the support arm 430 (e.g., relative to “horizontal”). Further, to this end, the nozzle assembly 440 includes a pan motor 446 for rotating the nozzle 441 about an axis that is orthogonal to the arm 430 (and may extend through the end of the outer arm 434). Both of these motors 444, 446 are operated in response to control signals from the controller to provide high frequency and finer tuning of the location of the nozzle 443 relative to a 3D surface to better implement paint commands associated with a paint trajectory that is annotated to a map or 3D model of the structure with the targeted surface.

The paintcopter 420 as shown in FIG. 4 may be implemented with the following system components: (a) a DJI Matrice 100 drone with a custom arm supporting a pan-tilt nozzle (or a nozzle assembly as discussed beginning with FIG. 5); (b) a Jetson TX2 with Astro carrier board for sensing and spray nozzle control (including the functionality and calibration discussed beginning with FIG. 5); (c) an Intel UP board for flight controller communication and position control; (d) a sensor unit (which may include a camera rigidly attached to the nozzle to facilitate calibration); (e) an offboard power source and power line; (f) an offboard paint supply/unit and paint lines (e.g., two or more lines providing two or more colors for mixing in the nozzle); and (g) an upper cage to prevent the paint and power line from contacting the rotating rotors.

In one prototype, the drone 420 was based upon a DJI Matrice 100 drone that is augmented with a custom arm and pan-tilt spray nozzle. The support arm may include three carbon fiber tubes in a triangular configuration, with 3D printed aluminum mounting plates and a total weight of about 140 grams. The pan-tilt nozzle has two servo motors to allow yaw movement (e.g., a range of plus/minus 90 degrees) and pitch movement (e.g., a range of plus/minus 45 degrees) of the nozzle. A further servo actuates the nozzle spray, with a controllable aperture between closed and open. A compliant spring is placed at the end of the arm and nozzle to prevent damage of the nozzle in case of unwanted contact with the painting surface (e.g., due to wind or the like). The onboard electronics have been shifted as far as possible to the opposite side of the drone from the arm so that center-of-mass remains close (e.g., within about 40 mm) to the center axis of the platform. The total weight of the modified drone was about 3800 grams.

In the prototype drone, the sensor unit included a DUO MX stereo camera+IMU and an Intel RealSense R200. They were calibrated against each other. The DUO MLX was used for visual odometry, while the Real Sense offered two modalities for capturing depth. Note, the RealSense was range limited but was valuable when the drone was close to the target surface. The offboard power was realized using a ground or offboard supply (1000 W 220AC/400DC step up converter) and onboard unit (2400 W 400DC/24DC step down converter). The drone battery was replaced by a custom high voltage DC/DC converter, along with a modification to the communication protocol so that the drone had unlimited flying time on a power line. The advantage of a high voltage tether between the offboard unit and the platform/body was that it allowed thin wires (22-24 AWG).

The offboard paint supply, in the prototype, took the form of an air compressor(s) operating at 1-3 bar and paint reservoirs. Each paint line was dedicated to a single color of paint, and swapping between paint lines was designed to be convenient and spill-free. A mesh cage was included on the prototyped drone to prevent the power and paint lines from coming into contact with the propellers of the drone, when the lines are positioned above the drone's flight position. The mesh cage was constructed from 2.5 mm thick carbon fiber tubes connected with 3D printed plastic parts to form a frame, which was covered with a mesh of nylon cord. Power and paint lines arrived from above the drone. Having the external lines above or below the drone is an application-dependent choice. For lines that come from below, drag limits the maximum height of the drone. For lines that come from above, drag is avoided but the external power and paint units must be positioned above the painting surface, e.g., on a roof of a building, on a cherry picker, or the like. For lines positioned above, there may also be a need for an automatic cable winder to keep the lines relatively taut.

To provide a 3D model/map, the target surface can be scanned (such as with software/procedures defined by commercial products such as Infinitam, Vempati IROS) with the drone under manual control. The scan generates a Truncated Signed Distance Field (TSDF), which is stored on disk/memory with its associated hash table as the 3D model for the target surface. The 3D model is subsequently used in the following two ways: (1) as a basis for designing the appearance of the target surface and (2) to provide the underlying scene representation and coordinate frame to which task planning commands like drone trajectory and spray-nozzle control are attached. The 3D model and task planning commands are used to guide the live system.

In the live system, the drone localizes against the physical surface using the stored 3D model and then implements the drone trajectory and spray nozzle (or paint) commands. Firstly, coarse localization of the drone relative to the target surface is carried out. Secondly, more accurate localization is then carried out using the onboard sensor output (e.g., sensors such as cameras providing visual odometry). The processing may be performed on a reserve memory (much smaller size) until a patch of the scene is mapped. This mapped scene is published as a ROS mesh message which is then processed by Fast Global Registration (FGR) node. FGR uses this mesh patch to find a global alignment with respect to the saved mesh. A further ICP step may be used to refine the alignment between the two meshes and publishes a correction transformation on the global reference frame. After applying this correction on its tracking state, localization may continue by processing the data from main memory. Depth integration is turned off, and pure localization is achieved using the stored data from the previous localization session/processing.

The drone's standard communication protocol between the flight controller and the battery was modified to allow for offboard power. In the default operation, the flight controller reads the data from the battery board (e.g., cell voltage, current, temperature, estimated remaining capacity, overall state of the battery, number of charging cycles, and the like) and, according to this data, lowers the flight time limit. Bridging the flight controller and battery board and changing these parameters (e.g., sending fictitious data to the flight controller) achieves unlimited flight time. Communication with the battery board also includes “heartbeat” messages, which does not allow the propellers to turn. Passing this message through the bridge without data alterations makes the flight controller think that the original battery is placed on the platform.

FIG. 5 is a functional block diagram of spray painting system 500 that includes a mobile robot 510 with a smart nozzle unit or assembly 520 of present description. As discussed earlier, the mobile robot 510 may take a wide variety of forms known in the outdoor painting industry including, but not limited to, a painting drone as discussed with reference to FIGS. 1-4, and the nozzle assembly 520 may be used in place of the nozzle 140 of FIGS. 1 and 2 and nozzle 440 of FIG. 4. The system 500 includes a paint supply (not shown but understood from FIGS. 1-4) that provides spray paint in lines 512-514 (two or more) to the nozzle assembly 520, and each line 512 may be used to provide paint of a different color (two or more colors of spray paint supplied to the nozzle assembly 520).

The smart nozzle assembly 520 includes a nozzle control mechanism or assembly 530 that provides a combination of functionality for the spray painting robot 510. In this regard, the nozzle assembly 520 includes an adjustable nozzle 534 and the nozzle control mechanism 530 acts to provide autonomous spray painting through selective control of paint supplied to the nozzle 534 and operations and/or settings of the nozzle 534. The nozzle control mechanism 530 includes a controller 532 that may include a processor running control software to provide control signals to a mixer 536, a flow rate controller 540, a self-cleaning device 542, and a spray pattern selector 546 to provide a combination of functions from one, two, three, or all four of these control mechanisms.

The mixer 536 is configured to take as input the paint of a first color from line 512 and the paint of a second (or Nth) color from line 514. The mixer 536 functions to mix these paints to output a mixture of two (or more) paints with a controllable (or selectable) ratio of the two (or more) input paints. For example, the mixer 536 may include a flow regulator for each line 512-514 to set a flow rate of each so as to set a mixing ratio. The mixer 536 may further include a mixing chamber downstream of these flow regulators for mixing these two (or more) colored paints prior to the mixture being transmitted through mixed color paint line 538 to an inlet of the nozzle 534. The nozzle control mechanism 530 may use these flow regulators of the mixer 536 to control the paint flow rate to and through the nozzle 534 and/or may include a separate flow rate controller 540 on line 538 to control the flow rate of paint in the nozzle assembly 520.

The nozzle control mechanism 530 also includes a self-cleaning device 542 that operates on an ongoing or at least periodic basis to clean off paint that has or will potentially block the outlet or aperture of the nozzle 534. The device 542 may removed dried paint or be configured to provide cleaning on the aperture or tip of the nozzle 534 so that paint cannot dry on the tip/aperture and block the nozzle 534. Additionally, the nozzle control mechanism 530 includes a spray pattern selector 546 that is operated by control signals from the controller 532 to adjust the nozzle 534 to control the shape of the spray pattern output by the nozzle 534. For example, the selector 546 may adjust the nozzle 534 to provide a cone pattern of a particular shape and/or size or to provide a more arbitrary shaped pattern on a targeted surface. In this manner, the nozzle control mechanism 530 combines two-to-four spraying functionalities in one nozzle assembly 520 that is desirable for use with a mobile robot 510 (versus a fixed robot arm or the like) to provide autonomous spray painting of structures such as rockworks and other outdoor structures with themed and/or multi-colored surfaces.

The nozzle assembly 520 further is adapted to provide two additional functionalities by including a calibration unit 550 and a camera 570 (e.g., a digital camera that typically is a video camera) rigidly attached to the nozzle 534 or mounted on a support structure or frame of the assembly 520 proximate to the nozzle 534. The calibration unit 550 processes output (i.e., digital images) from the camera 570 including those of the calibration target(s) 590 during painting operations using the nozzle 534 to: (1) provide calibration of the spray pattern; and (2) provide calibration of the nozzle position relative to the onboard camera 570. With regards to calibrating the spray pattern, calibration means to measure a parametric or non-parametric model of the spray pattern. Given such a model, the spray pattern on a surface can subsequently be predicted. Calibrating of the camera-to-nozzle relative position may be called determining the “extrinsic parameters” in a traditional stereo vision system or traditional projector-camera system.

To this end, the calibration unit 550 includes a processor (or CPU) running a set of code or software (that defines a calibration algorithm(s)) to provide the functionality of a calibration module 554. The calibration unit 550 also includes memory or data storage devices 560 managed by the processor 552, and the memory 560 stores the camera images 572 received from the onboard camera 572. The memory 560 also is used by the calibration module 554 to store the parameters it uses in performing its calibration algorithms and its output. As shown, the memory 560 stores a measured or determined spray pattern 580 for the nozzle 534, a distribution of paint in the spray pattern 582 (e.g., measured in terms of physical quantity of delivered paint (e.g., ml) per unit area), and a relative position of the nozzle and camera 584.

The following provides a more detailed description of the calibration methods and algorithms carried out by the smart nozzle assembly (such as assembly 520 of FIG. 5). The underlying intuition of the inventors is that a spray nozzle can be treated like a pinhole. With the addition of a camera in the nozzle unit/assembly (e.g., the camera 570 in nozzle assembly 520 of FIG. 5), calibrating a camera-nozzle unit is very similar to calibrating a projector-camera unit. The goal of the inventors in designing the calibration unit 550 of FIG. 5 is guided by having a nozzle calibration method that is practical and easy to use in a regular maintenance setting.

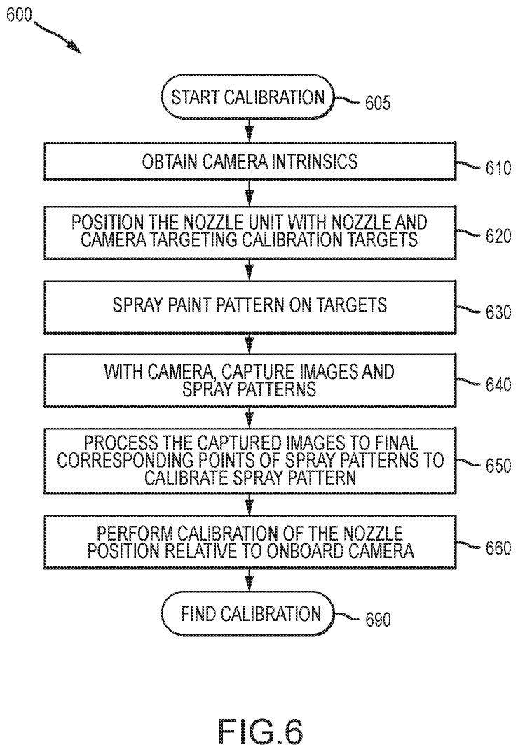

FIG. 6 illustrates a calibration method 600 carried out by a smart nozzle assembly of the present description (such as by calibration unit 550 of the nozzle assembly 520 in FIG. 5). The calibration method 600 may start at 605 such as with loading and running calibration software (e.g., module 554) on a nozzle unit. The physical system is a nozzle plus a camera with calibrated intrinsics. Hence, step 605 may include mounting a camera on a nozzle or on a support frame of a nozzle unit that is supporting the nozzle. Then, the method 600 continues at 610 with obtaining the camera intrinsics such as by using a standard toolkit like OpenCV or the like.

The nozzle parameters that are to be computed as part of method 600 can be defined as the cone defined by the spray pattern. Herein, the term “cone” is being used in the general sense such as using the definition in Wikipedia that states “Depending on the author, the base may be restricted to be a circle, any one-dimensional quadratic form in the plane, any closed one-dimensional figure, or any of the above plus all the enclosed points.” In addition to the cone, the calibration method 600 determines a further calibration parameter for a nozzle in the form of its fall-off of the spray with distance. In summary, the requirement is to measure the cone defined by the spray pattern in the camera coordinate frame, e.g., the (X,Y,Z) of the vertex of the cone and a parametric model of the cone shape where applicable or a non-parametric model of the cone shape if it is not parameterizable.

The method 600 continues with positioning, via operation of the mobile robot, the nozzle unit with its nozzle and associated camera targeting calibration targets as shown at 620. Then, the nozzle unit is operated at 630 to spray paint a pattern of paint onto the calibration targets. At step 640, the camera is operated to capture images of the spray patterns for analysis by the calibration module. In one embodiment of method 600, these steps involve fixing the camera-nozzle unit in front of a set of parallel planar sheets at known increasing distances from the nozzle outlet/aperture. For example, there may be just two parallel planar sheets, P1 and P2, although the calibration method extends to any number, N, of sheets/calibration targets. The nozzle is operated by its control mechanism to spray first on the closest sheet, P1, and the spray pattern is recorded with the camera. The sheet, P1, is removed, and the process is repeated on the next sheet, P2.

The method 600 continues at 650 with processing the captured images to find corresponding points in the captured spray patterns. Consider the two spray patterns obtained in step 650 and one can call the silhouettes in the camera image S1 and S2. Each generatrix of the cone (again, refer to the general cone definition given, for example, by Wikipedia) hits a point on S1 and a corresponding point on S2. Thus, assuming one has a method to find corresponding points on the two silhouettes, S1 and S2, the generatrices of the cone can be computed. The generatrices can also be intersected to find the vertex of the cone. This method works when the cone is non-parametric (e.g., the base is a closed one-dimensional figure) which is a superset of the case that the cone is parametric such as a right-circular cone.

The requirement now is to find the corresponding points on silhouettes of spray patterns, S1 and S2. Two observations are relevant to this calculation. First, given camera images of S1 and S2, corresponding point on S1 and S2 are related by a homography. A homography is normally used to relate two viewpoints of a fixed plane by a moving camera. It will be intuitively clear that a spray pattern on two parallel planes viewed by a fixed camera is effectively the same as a moving camera observing a spray pattern on a single fixed plane. Second, a further observation (unrelated to the first observation) is that the most straightforward calibration case, which is also the most relevant case for a spray nozzle, is when the cone is a right circular cone. A right circular cone intersects a planar sheet as an ellipse or circle for the calibration configurations that are considered herein.

At this point with regard to step 650, computation of the homography between S1 and S2 can be described in detail. First, it is assumed that the pattern is being sprayed onto planar sheets that have a grid pattern, and the grid pattern is aligned the same way on the two (or more) parallel sheets, P1 and P2. For the camera image of S1, step 650 involves finding the vanishing points, V1a and V1b, for the two directions of the grid. Tangent lines are drawn from V1a to the ellipse to find the tangent points, T1 and T2. Then, the tangent lines are drawn from V1b to the ellipse to find the tangent points, T3 and T4. These four tangent points, T1-T4, are projective invariants (e.g., see, “Robust Detection and Ordering of Ellipses on a Calibration Pattern” by Alvarez et al., published 2004). This process is then repeated for the second spray pattern image, S2, to generate V2a, V2b, T′ 1, T′2, T′3, and T′4. This provides two sets of six corresponding point, which are used in step 650 to compute the homography between spray pattern images, S1 and S2. Given the homography, the corresponding points on spray pattern images, S1 and S2, are generated. Note also that this method works if the silhouettes, S1 and S2, are circles because the grid pattern overcomes the ambiguity.

The calibration method 600 then continues on at 660 with calibration of the nozzle position relative to the onboard camera. The method 600 then ends at 690, and the results of the calibration can be used by the nozzle control mechanism to more accurately operate the nozzle to spray paint a surface with a desired pattern and/or colors of paint. Step 660 involves addressing the issue of how to move the collected date and/or information into three dimensional (3D) space. This can be a performed in a relatively straightforward manner. Sheets P1 and P2 can be printed with a grid of known dimensions, and the camera is calibrated. Hence, it is possible to use a PnP process (e.g., Perspective-n-Point discussed at least in Wikipedia) known to those skilled in the art to compute the camera position in 3D space. It is also possible to compute the position of any point on spray pattern image S1 or spray pattern image S2 in 3D space. With the results of these calculations in hand, corresponding points on image S1 and S2 (obtained from the homography in step 650) are used to determine generatrices of the cone. The intersection point of the generatrices is the vertex of the cone.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A system for autonomous spray painting, comprising:
a mobile robot; and
a nozzle assembly mounted on the mobile robot, comprising:
a nozzle;
a camera;
a nozzle control mechanism; and
a calibration unit,
wherein, during a calibration process, the nozzle control mechanism operates to output a flow of paint through the nozzle in at least first and second spray patterns,
wherein, during the calibration process, the camera captures images of the first and second spray patterns, and
wherein the calibration unit processes the images of the first and second spray patterns to calibrate the nozzle.

2. The system of claim 1, wherein the camera is rigidly supported in the nozzle assembly at a location relative to an outlet of the nozzle.

3. The system of claim 2, wherein the calibration unit is configured to calibrate a position of the nozzle relative to the camera.

4. The system of claim 1, wherein the calibration unit calibrates the nozzle by measuring a parametric or non-parametric model of the first and second spray patterns.

5. The system of claim 1, wherein the calibration unit calibrates the nozzle by positioning the nozzle to apply the first and second spray patterns on first and second parallel calibration targets at known distances from the nozzle and wherein the images of the first and second spray patterns include the first and second calibration targets.

6. The system of claim 5, wherein the calibration unit calibrates the nozzle by finding corresponding points in the first and second spray patterns.

7. The system of claim 6, wherein the finding of the corresponding points comprises computing a homography between the images of the first and second spray patterns.

8. The system of claim 1, wherein the calibration of the nozzle by the calibration unit comprises at least one of measuring the first and second spray patterns and measuring the distribution of the paint within the first and second spray patterns in terms of physical quantity of delivered paint per unit area.

9. The system of claim 1, wherein the nozzle control mechanism includes at least two of a flow rate controller operable to set a rate of the flow of the paint through the nozzle, a mixer mixing two or more input paint flows of two or more differing colors to define a color of the paint flowing through the nozzle having a predefined ratio of the two or more differing colors, a spray pattern selector adjusting the nozzle to define a shape of a spray pattern output by the nozzle, and a self-cleaning device operable to remove paint buildup from an outlet of the nozzle.

10. A system for autonomous spray painting, comprising:
a mobile robot; and
a nozzle assembly positionable by the mobile robot, comprising:
a nozzle; and
a nozzle control mechanism including a flow rate controller operable to set a rate of flow of paint through the nozzle, a mixer mixing two or more input paint flows of two or more differing colors to define a color of the paint flowing through the nozzle, a spray pattern selector adjusting the nozzle to define a shape of a spray pattern output by the nozzle, and a self-cleaning device operable to remove paint buildup from an outlet of the nozzle,

11. The system of claim 10, wherein the nozzle assembly further comprises a calibration unit generating a set of parameters defining a calibration of the nozzle and wherein the nozzle control mechanism operates to set the rate of flow of the paint or to adjust the nozzle to achieve a desired spray pattern based on the calibration of the nozzle.

12. The system of claim 10, wherein the nozzle assembly further includes a camera rigidly supported at a position relative to the nozzle and a calibration unit and wherein, during a calibration process, the nozzle control mechanism operates to output the paint through the nozzle in at least first and second spray patterns, wherein, during the calibration process, the camera captures images of the first and second spray patterns, and wherein the calibration unit processes the images of the first and second spray patterns to calibrate the nozzle.

13. The system of claim 12, wherein the calibration unit calibrates the nozzle by measuring a parametric or non-parametric model of the first and second spray patterns.

14. The system of claim 12, wherein the calibration unit calibrates the nozzle by positioning the nozzle to apply the first and second spray patterns on first and second parallel calibration targets at known distances from the nozzle and wherein the images of the first and second spray patterns include the first and second calibration targets.

15. The system of claim 14, wherein the calibration unit calibrates the nozzle by finding corresponding points in the first and second spray patterns and wherein the finding of the corresponding points comprises computing a homography between the images of the first and second spray patterns.

16. The system of claim 12, wherein the calibration of the nozzle by the calibration unit comprises at least one of measuring the first and second spray patterns and measuring the distribution of the paint within the first and second spray patterns in terms of physical quantity of delivered paint per unit area.

17. A system for autonomous spray painting, comprising:
a nozzle;
a camera rigidly supported at a position relative to the nozzle;
a nozzle control mechanism; and
a calibration unit calibrating the nozzle based on output from the camera during calibration operations of the nozzle, wherein the nozzle control mechanism predicts and operates the nozzle to output a flow of paint in a predefined pattern based on the calibrating of the nozzle.

18. The system of claim 17, wherein, during the calibration operations, the nozzle control mechanism operates to output a flow of paint through the nozzle in at least first and second spray patterns, wherein, during the calibration process, the camera captures images of the first and second spray patterns, and wherein the calibration unit processes the images of the first and second spray patterns to calibrate the nozzle.

19. The system of claim 18, wherein the calibrating by the calibration unit includes measuring a parametric or non-parametric model of the first and second spray patterns.

20. The system of claim 18, wherein the calibrating of the nozzle includes positioning the nozzle to apply the first and second spray patterns on first and second parallel calibration targets at known distances from the nozzle and wherein the images of the first and second spray patterns include the first and second calibration targets, wherein the calibration unit calibrates the nozzle by finding corresponding points in the first and second spray patterns, and wherein the finding of the corresponding points comprises computing a homography between the images of the first and second spray patterns.

21. The system of claim 18, wherein the calibrating of the nozzle by the calibration unit comprises at least one of measuring the first and second spray patterns and measuring the distribution of the paint within the first and second spray patterns in terms of physical quantity of delivered paint per unit area.

22. The system of claim 17, wherein the nozzle control mechanism includes at least two of a flow rate controller operable to set a rate of the flow of the paint through the nozzle, a mixer mixing two or more input paint flows of two or more differing colors to define a color of the paint flowing through the nozzle having a predefined ratio of the two or more differing colors, a spray pattern selector adjusting the nozzle to define a shape of a spray pattern output by the nozzle, and a self-cleaning device operable to remove paint buildup from an outlet of the nozzle.
